(19) United States
(12) Patent Application Publication
(10) Pub. No.: US 2004/0010062 A1
(43) Pub. Date: Jan. 15, 2004

(54) Polyimide copolymer and methods for preparing the same

(76) Inventors: Byeong-In Ahn, Daejeon-city (KR); You-Jin Kyung, Daejeon-city (KR); Joo-Eun Ko, Seoul (KR); Heon-Sik Song, Daejeon-city (KR)

Correspondence Address: CANTOR COLBURN, LLP, 55 GRIFFIN ROAD SOUTH, BLOOMFIELD, CT, 06002

(21) Appl. No.: 10/399,577

(22) PCT Filed: Sep. 27, 2002
(86) PCT No.: PCT/KR02/01828

(30) Foreign Application Priority Data
Sep. 27, 2001 (KR) 2001-0060252
Sep. 27, 2002 (KR) 2002-0058609

(51) Int. Cl. C08K 3/00; C08L 79/00

(52) U.S. Cl. 524/238; 528/310

(57) ABSTRACT

The present invention relates to a polyimide copolymer used in a precursor of heat resistant adhesive and methods for preparing the same, and more particularly, to a polyamic acid copolymer and methods for preparing the same obtained by controlling a polymerization degree of the tetracarboxylic acid dianhydride and aromatic diamine. The present invention also comprises a polyimide copolymer obtained by curing the polyamic acid copolymer, and methods for preparing the same. The present invention also provides a heat resistant adhesive composition comprising the polyamic acid copolymer and the polyimide copolymer, and a semiconductor device using the same. The polyamic acid copolymer used in a precursor and polyimide copolymer obtained therefrom of the present invention has superior adhesion strength and simultaneously satisfies physical properties like high heat resistance and low water absorption rate, etc. and thus it can be effectively adhered parts of semiconductor devices, etc.

### BACKGROUND OF THE INVENTION

(a) Field of the Invention

The present invention relates to a polyimide copolymer and methods for preparing the same, and more particularly to a polyimide copolymer and methods for preparing the same, which has superior adhesion strength, and simultaneously satisfies high heat resistance, and low water absorption rate, and thus parts of semiconductor devices etc. can be effectively adhered.

(b) Description of the Related Art

Generally, peripheral components comprising electronic parts, particularly semiconductor devices such as in IC packaging are adhered using a soldering method. However, because in IC packaging, a circuit line width becomes narrower and lead used in soldering causes environmental problems, a novel soldering method which does not use lead is required and thus an adhesive with high adhesion strength, high heat resistance, and a low water absorption rate is required so as to withstand soldering at 300° C. or higher.

In IC packaging, epoxy, acrylic, polyester and others. have been mainly used as an adhesive. However, although they have superior adhesion strength, they have disadvantages in heat resistance and water absorption rate.

Therefore, polyimide is used as an adhesive, simultaneously satisfying adhesion strength and heat resistance, but it cannot simultaneously satisfy adhesion strength, high heat resistance, and low water absorption rate.

U.S. Pat. No. 6,015,607 has described a flexible laminate adhering polyimide and copper foil using Ultem™ or Siltem™ made by adding silicone in an Ultem™-like structure. Additionally, U.S. Pat. No. 5,157,589 has described a method of using heat resistant adhesive with a different glass transition temperature while preparing a circuit substrate.

However, according to these two methods, the water absorption rate is superior but the adhesion strength is still inferior.

### SUMMARY OF THE INVENTION

The present invention is made in consideration of the problems of the prior art, and it is one object of the present invention to provide a polyamic acid copolymer using as a precursor of a polyimide copolymer, and having superior heat resistant and adhesion strength with metal, and methods for preparing the same.

It is another object of the present invention to provide a polyimide copolymer that has a low water absorption rate and superior heat resistance while satisfying various physical properties, and thus can be used as an adhesive in IC packaging, etc., and methods for preparing the same.

It is another object of the present invention to provide a heat resistant adhesive composition comprising a polyamic acid copolymer or a polyimide copolymer.

It is another object of the present invention to provide a semiconductor device packaged by using the heat resistant adhesive composition.

In order to achieve these objects, the present invention provides a polyamic acid copolymer of a compound represented by the following Formula 2a, 2b, 2c, and 2d:

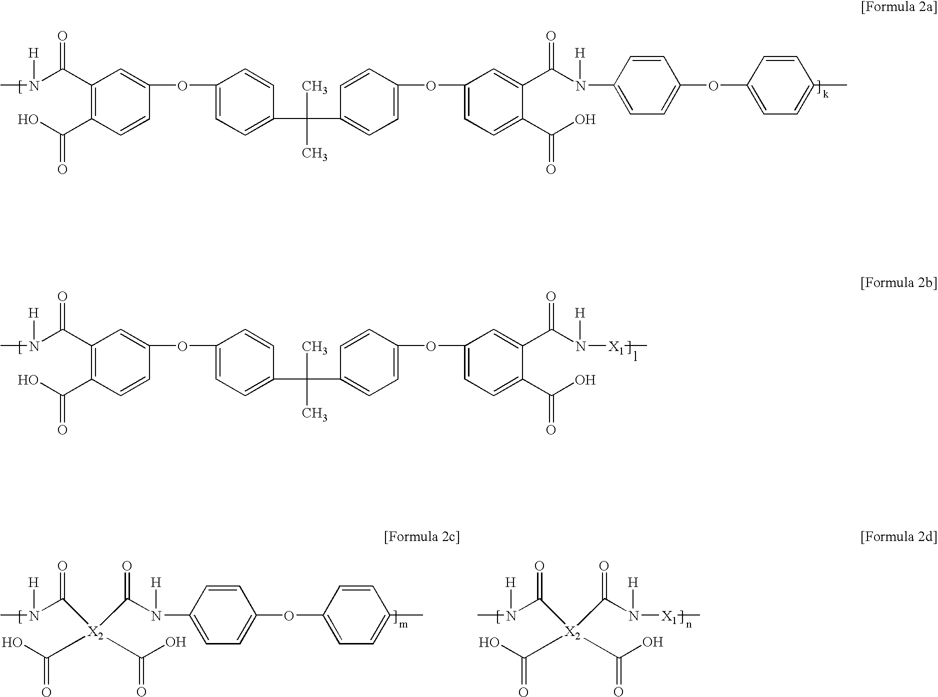

(In the above Chemical Formula 2a to 2d,

X₁ is a divalent organic substance with a structure of one or more kinds selected from the group consisting of

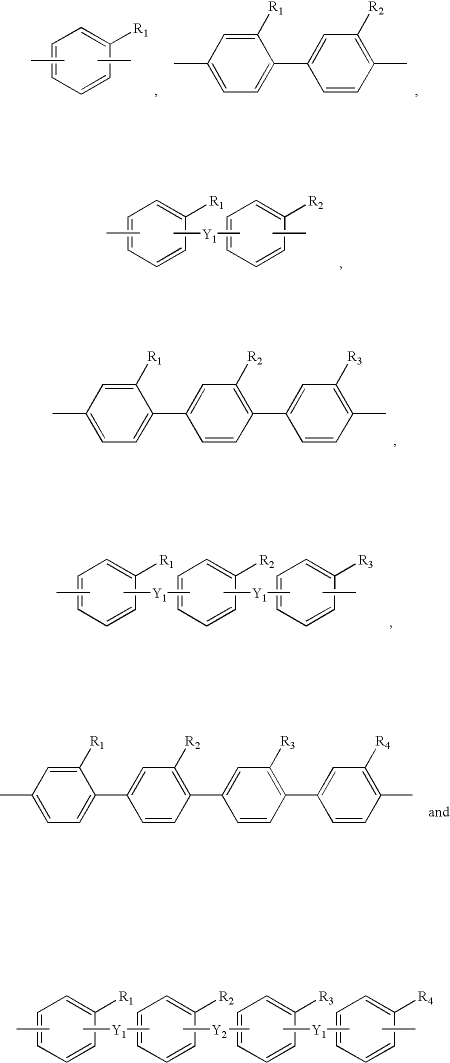

(wherein R₁, R₂, R₃, and R₄ are independently or simultaneously a hydrogen, methyl, hydroxy, or methoxy group; Y₁ and Y₂ are independently or simultaneously —O—, —CO—, —S—, —SO₂—, —C(CH₃)₂—, —CONH—, or —O(CH₂)ₙO— (wherein, n is an integer of 1 to 5.));

X₂ is a tetravalent organic substance with a structure of

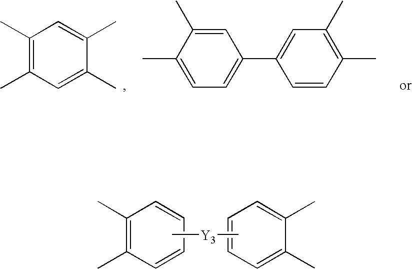

(wherein Y₃ is —O—, —CO—, or —CO₂(CH₂)ₙO₂C— (n is an integer of 1 to 5)); and

k is an integer of 1 or more; and l, m, and n are independently integers of 0 or more, but there are not 0 simultaneously, provided that k≧l, k+l>1.5(m+n), and k+m>1.5(l+n).)

The present invention also provides a method for preparing the polyamic acid copolymer of a compound represented by the Formula 2a, 2b, 2c, and 2d, comprising the steps of:

polymerizing

a) one or more kinds of tetracarboxylic acid dianhydride; and

b) one or more kinds of aromatic diamine

by the equivalent ratio of 0.9:1˜1:0.9 under an organic solvent.

The present invention also provides a polyimide copolymer of a compound represented by the following Formula 1a, 1b, 1c, and 1d:

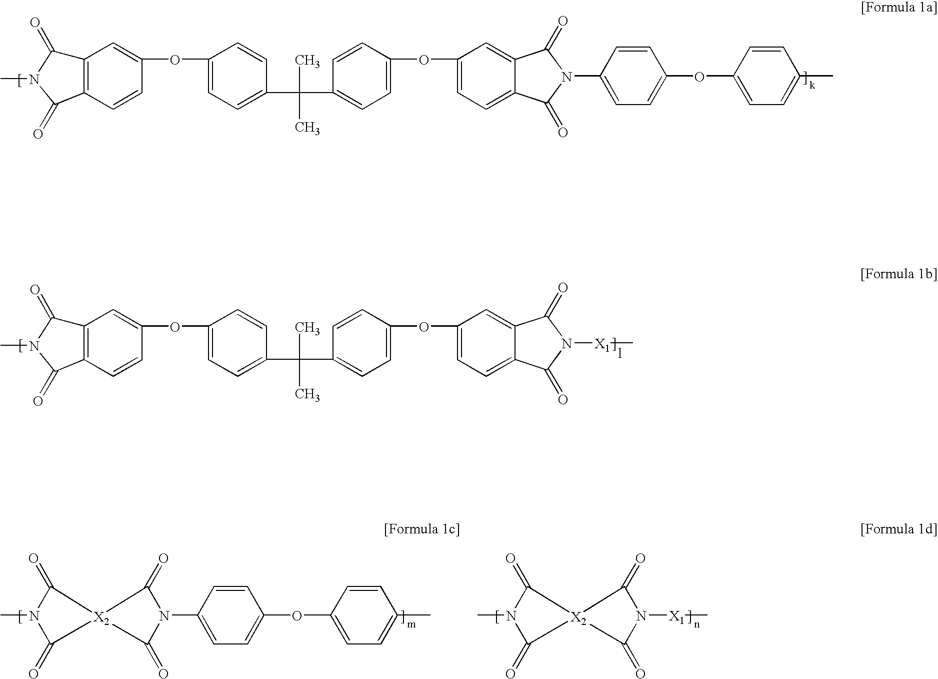

(In the above Chemical Formula 1a to 1d,

X₁ is a divalent organic substance with a structure of one or more kinds selected from the group consisting of

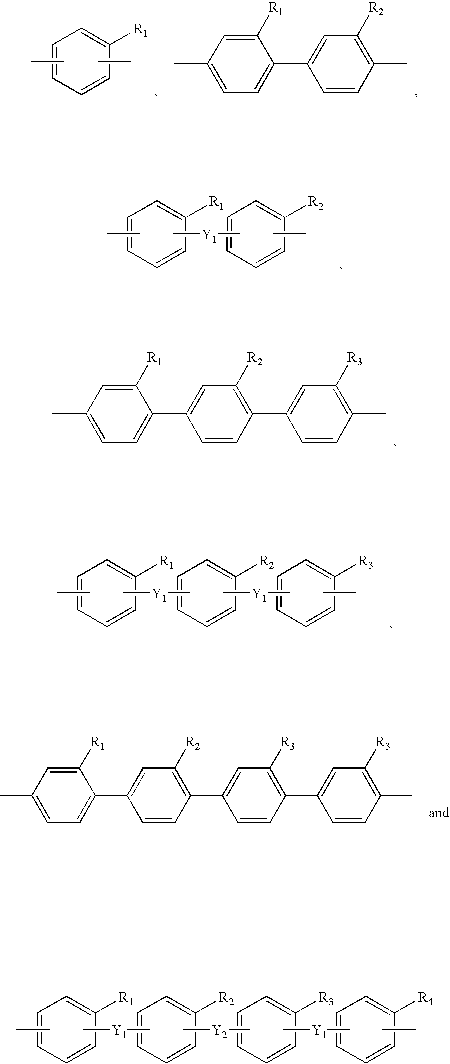

(wherein R₁, R₂, R₃, and R₄ are independently or simultaneously a hydrogen, methyl, hydroxy, or methoxy group; Y₁ and Y₂ are independently or simultaneously —O—, —CO—, —S—, —SO₂—, —C(CH₃)₂—, —CONH—, or —O(CH₂)ₙO— (wherein, n is an integer of 1 to 5.));

X₂ is a tetravalent organic substance with a structure of

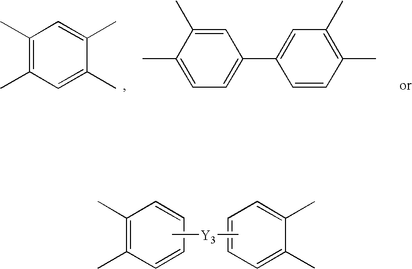

(wherein Y₃ is —O—, —CO—, or —CO₂(CH₂)nO₂C— (n is an integer of 1 to 5)); and

k is an integer of 1 or more; and l, m, and n are independently integers of 0 or more, but there are not 0 simultaneously, provided that k≧l, k+l>1.5(m+n), and k+m>1.5(l+n).)

The present invention also provides a method for preparing the polyimide copolymer of a compound represented by the Formula 1a, 1b, 1c, and 1d, comprising the steps of:

converting to polyimide by heating the polyamic acid copolymer of a compound represented by the following Formula 2a, 2b, 2c, and 2d.

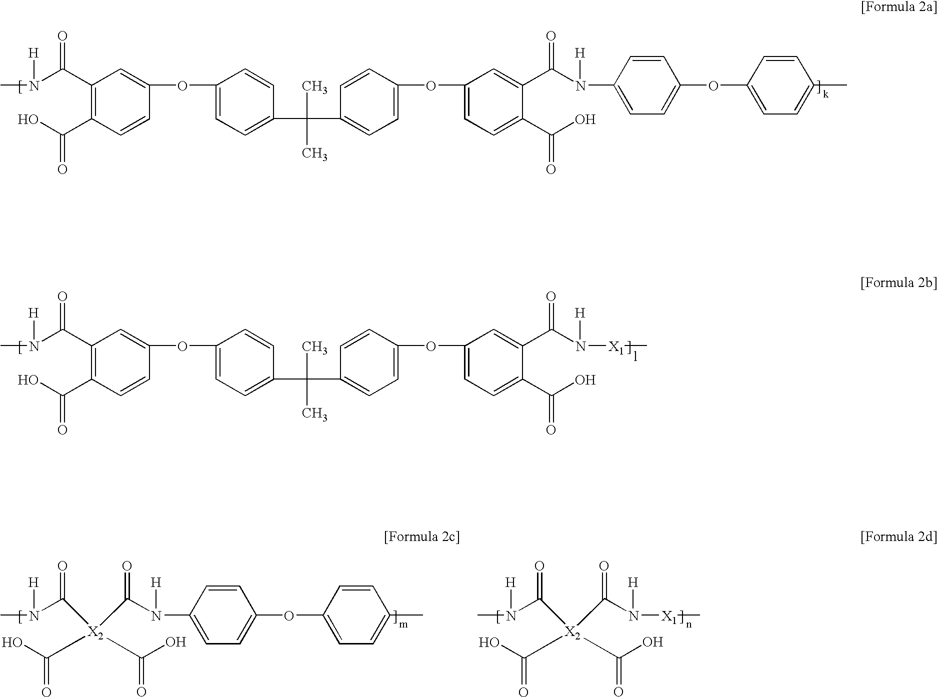

(In the above Chemical Formula 2a to 2d,

X₁ is a divalent organic substance with a structure of one or more kinds selected from the group consisting of

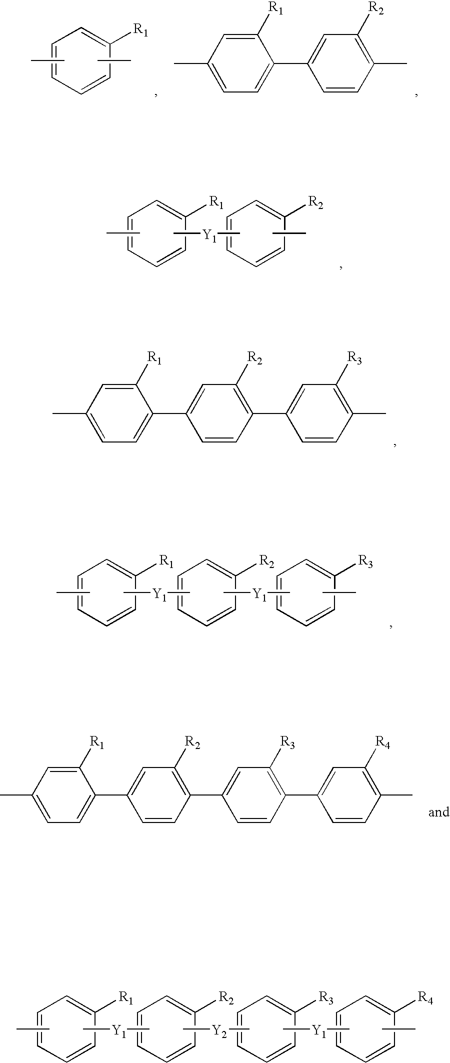

(wherein R₁, R₂, R₃, and R₄ are independently or simultaneously a hydrogen, methyl, hydroxy, or methoxy group; Y₁ and Y₂ are independently or simultaneously —O—, —CO—, —S—, —SO₂—, —C(CH₃)₂—, —CONH—, or —O(CH₂)ₙO— (wherein, n is an integer of 1 to 5.));

X₂ is a tetravalent organic substance with a structure of

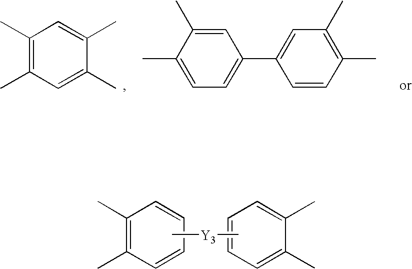

(wherein Y₃ is —O—, —CO—, or —CO₂(CH₂)ₙO₂C— (n is an integer of 1 to 5)); and

k is an integer of 1 or more; and l, m, and n are independently integers of 0 or more, but there are not 0 simultaneously, provided that k≧l, k+t>1.5(m+n), and k+m>1.5(l+n).)

The present invention also provides a heat resistant adhesive composition comprising:

a) the polyamic acid copolymer of a compound represented by the Formula 2a, 2b, 2c, and 2d, or a polyimide copolymer of a compound represented by the Formula 1a, 1b, 1c, and 1d; and b) organic solvent.

The present invention also provides a semiconductor device packaged by using the heat resistant adhesive composition.

### DETAILED DESCRIPTION AND THE PREFERRED EMBODIMENTS

The present invention will now be explained in detail.

The present invention provides polyamic acid and method for preparing the same, which can be used in a precursor of polyimide copolymer and a heat resistant adhesive. The present invention also provides polyimide copolymer that has superior adhesion strength, low water absorption rate, and superior heat resistance, and thus it can be used for an adhesive for electronic parts of semiconductors, etc., and method for preparing the same.

The polyamic acid copolymer of compound represented by the above Chemical Formula 2a, 2b, 2c, and 2d is prepared by polymerizing one or more kinds of tetracarboxylic acid dianhydride, and one or more kinds of aromatic diamine, under an organic solvent.

The polymerization from monomers into polyamic acid copolymer is an equilibrium reaction, because the temperature may be increased due to rapid polymerization, as the reaction temperature is low, a progress into polyamic acid copolymer is preferred. Therefore the polymerization is preferably conducted at 0 to 60° C. If the temperature is higher than 60° C., polyamic acid with a desired molecular weight cannot be obtained.

According to the present invention, because an equivalent ratio of the tetracarboxylic acid dianhydride and the aromatic diamine plays a critical role in molecular weight, it is required to exactly control equivalents in order to obtain a desired molecular weight. However, if the molecular weight is too large, fluidity of the adhesive is limited, and if the molecular weight is too small, the adhesive is easily broken and thus destruction occurs at that part to lower adhesive strength.

Accordingly, in the present invention, it is preferable to make the equivalent ratio be 0.9:1˜1:0.9 and thus maintain an inherent viscosity of 0.2 dl/g or more, and preferably 0.2 to 0.5 dl/g. The molecular weight can also be controlled using monomers having one functional group that can participate in polymerization, such as aniline or phthalic acid anhydride.

The tetracarboxylic acid dianhydride is selected from the group consisting of pyromellitic acid dianhydride (PMDA), 3,3′,4,4′-biphenyl tetracarboxylic acid dianhydride (BPDA), 4,4′-oxydi(phthalic acid anhydride) (ODPA), 3,3′,4,4′-benzophenone-tetracarboxylic acid dianhydride (BTDA), trimellitic acid ethylene glycol dianhydride (TMEG), bisphenol-A-diphthalic acid dianhydride (BPADA), and a mixture thereof.

The aromatic diamine is selected from the group consisting of 1,3-phenyldiamine (MPDA), 4,4′-oxydianiline (4,4′-ODA), 3,4′-oxydianiline (3,4′-ODA), 4,4′-diaminobenzanilide (DABA), 3,3′-dihydroxy-4,4′-diaminobiphenyl (HAB), 1,4-di(4-aminophenyl)butane (DAPB), 1,3-bis(3-aminophenoxy)benzene (APB), 4,4′-1,3-phenylene diisopropylidene)dianiline (PDPDA), 2,2-bix[4-(4-aminophenoxy)phenyl]propane (BAPP), bis[4-(3-aminophenoxy)phenyl]sulfone (BAPSM), and a mixture thereof.

As the organic solvent, solvents having a polar group such as alcohol, ether, ketone, amide, and sulfur monooxide are preferably used. For example, it is preferably selected from the group consisting of N-methyl-2-pyrrolidone (NMP), N,N-dimethylacetamide (DMAc), N,N-dimethylformamide (DMA), dimethylsulfoxide (DMSO), and a mixture thereof.

The present invention also provides a polyimide copolymer consisting of a compound represented by the following Formula 1a, 1b, 1c, and 1d.

The polyimide copolymer of the present invention shows a glass transition temperature of 150 to 250° C. and thus it can be adhered at 400° C. or less, which is lower than the decomposition temperature of a common adhesive. Its water absorption rate is 3% or less when immersed in a water bath for 24 hours, its adhesion strength with metal is 1.0 kg/cm² or more, and its average linear expansion coefficient is 40 to 70 ppm/°C. at room temperature, which is below the glass transition temperature.

In the compound of the present invention represented by the above Chemical Formula 1a, 1b, 1c, or 1d, X₁ is preferably a divalent organic substance of one or more kinds selected from the group consisting of the compounds of the following Chemical Formula:

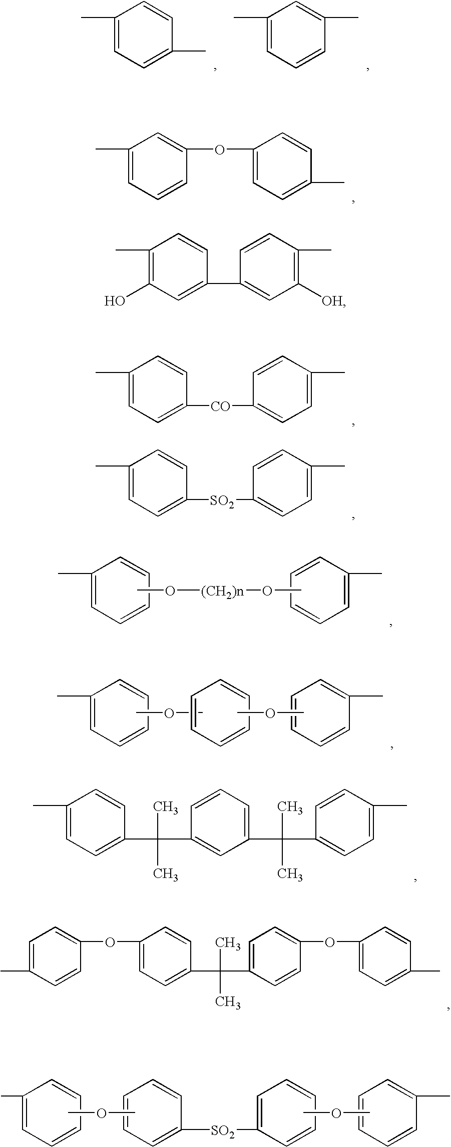

in the above Chemical Formula, n is an integer of 2 to 5.

The polyimide copolymer of the present invention is obtained from a polyamic acid copolymer of compound represented by the above Chemical Formula 2a, 2b, 2c, and 2d as precursor, by heating the polyamic acid copolymer to cure it.

In the present invention, the polyamic acid copolymer can be cured using a chemical method. Specifically, the polyamic acid copolymer can be reacted at room temperature and then cured by adding pyridine and acetic acid anhydride, or it can be reacted at a temperature range of 140 to 400° C. where imidation rapidly occurs to cause imidation. Therefore, the heat temperature is preferably 140 to 400° C.

The present invention also provides a heat resistant adhesive composition comprising a) the polyamic acid copolymer of a compound represented by the Formula 2a, 2b, 2c, and 2d, or a polyimide copolymer of a compound represented by the Formula 1a, 1b, 1c, and 1d; and b) organic solvent.

The content of the polyamic acid copolymer is preferably 10 to 30 wt % based on the total composition so as to control exothermic reaction, dissolve the polyamic acid copolymer that is reactant, and stir uniformly.

The content of the polyimide copolymer is preferably 10 to 50 wt % based on the total composition.

The organic solvent can be used a compound selected from the group consisting of N-methyl-2-pyrrolidone (NMP), N,N-dimethylacetamide (DMAc), N,N-dimethylformamide (DMA), dimethylsulfoxide (DMSO), and a mixture thereof.

In addition, the adhesive composition of the present invention may further comprise an additive selected from the group consisting of an antifomating agent, a gel preventing agent, and a curing accelerator at need.

The present invention can be prepared an adhesive in the form of a film by directly coating the polyamic acid copolymer obtained in the above process on metal and thermally-curing. The present invention also can be prepared an adhesive in the form of a film by directly coating the polyamic acid copolymer on metal and thermally-curing and pressurizing to adhere it. In addition, the present invention can be applied to a laminator by manufacturing in the film the polyimide copolymer by itself.

The adhesive film can be inserted between metal and metal or metal and a polymer film and then compressed in a press at 200 to 400° C. under 1 to 100 kg/cm² for 1 sec to 10 minutes, or it can be continuously adhered using a laminator.

Therefore, the present invention can be provided an electric product that has superior adhesive strength between the surrounding parts constructing a semiconductor device by using in IC packaging the heat resistant adhesive composition or adhesive film obtained by the above, and can be provided preferably a semiconductor device.

The present invention will be explained in more detail with reference to the following Examples. However, these are to illustrate the present invention and the present invention is not limited to them.

### [EXAMPLE]

Structures of monomers used in Examples and Comparative Examples are as follows:

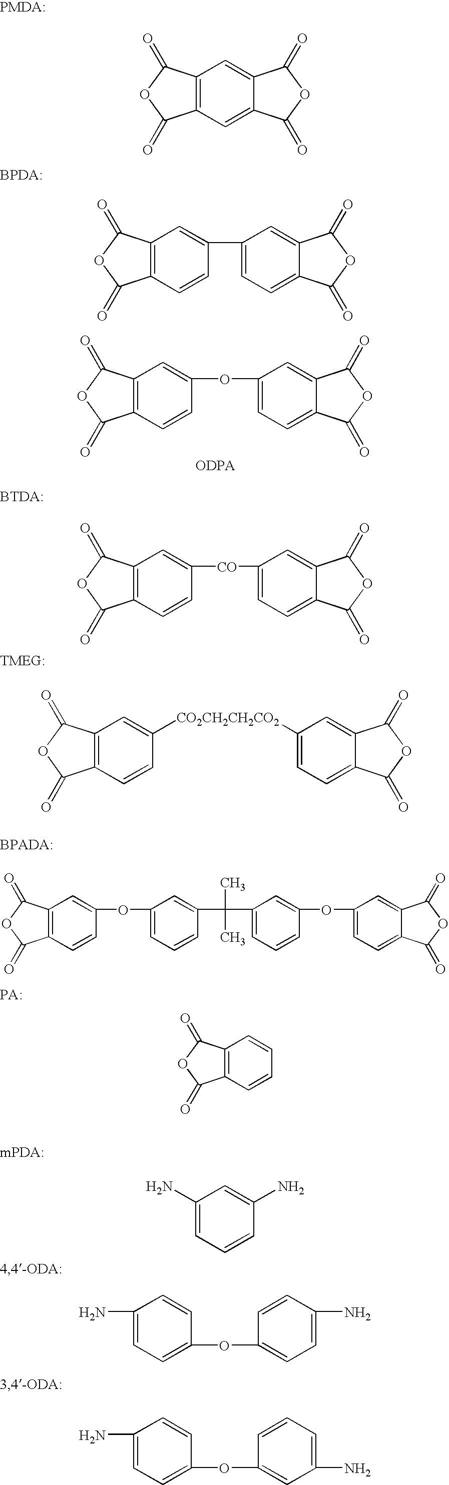

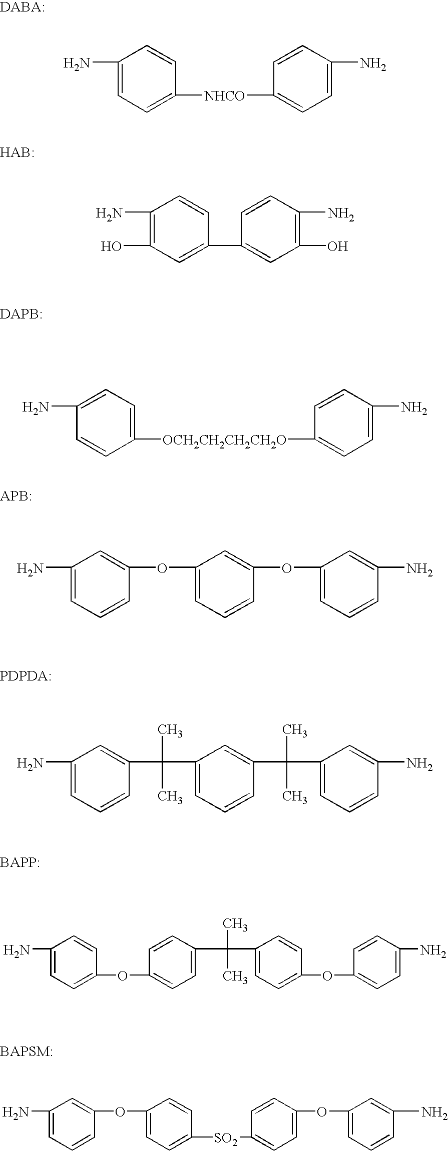

### [Example 1]

Preparation of Polyamic Acid Copolymer

The atmosphere in a flask was substituted with nitrogen, and 50 ml of NMP solvent and 2.464 g of 4,4′-ODA and 0.887 g of mPDA were introduced. After the 4,4′-ODA and mPDA was completely dissolved, 10.675 g of BPADA were introduced while maintaining 0° C., and then the mixture was agitated for 24 hours to complete polymerization, thereby preparing polyamic acid copolymer.

### [Examples 2 to 16]

As shown in the following Table 1, the polyamic acid copolymers were obtained by the same method as in Example 1 while changing monomers and compositions of monomers.

### [Comparative Example 1]

After substituting the atmosphere in a flask with nitrogen, 60 ml of NMP solvent and 5.749 g of 4,4′-ODA were introduced. After completely dissolving the 4,4′-ODA, 9.251 g of BTDA were introduced while maintaining 0° C., and then the mixture was agitated for 24 hours to complete polymerization, thereby preparing polyamic acid copolymer.

### [Comparative Example 2]

Polyamic acid copolymer was prepared by the same method as in Example 1, except that the composition was changed as shown in Table 1.

TABLE 1

| | Compositional ingredients | | | | Compositional ratio (mole ratio) | | | |
|---|---|---|---|---|---|---|---|---|
| | Anhydride | Anhydride | Amine | Amine | Anhydride | Anhydride | Amine | Amine |
| | (1) | (2) | (1) | (2) | (1) | (2) | (1) | (2) |
| Example 1 | BPADA | — | 4,4′- | mPDA | 100 | — | 60 | 40 |
| | | | ODA | | | | | |
| Example 2 | BPADA | — | 4,4′- | 3,4′- | 100 | — | 60 | 40 |
| | | | ODA | ODA | | | | |
| Example 3 | BPADA | — | 4,4′- | DABA | 100 | — | 80 | 20 |
| | | | ODA | | | | | |
| Example 4 | BPADA | — | 4,4′- | HAB | 100 | — | 80 | 20 |
| | | | ODA | | | | | |
| Example 5 | BPADA | — | 4,4′- | DAPB | 100 | — | 90 | 10 |
| | | | ODA | | | | | |
| Eaxmple 6 | BPADA | — | 4,4′- | APB | 100 | — | 80 | 20 |
| | | | ODA | | | | | |
| Example 7 | BPADA | — | 4,4′- | PDPBA | 100 | — | 70 | 30 |
| | | | ODA | | | | | |
| Examle 8 | BPADA | — | 4,4′- | BAPP | 100 | — | 70 | 30 |
| | | | ODA | | | | | |
| Example 9 | BPADA | — | 4,4′- | BAPSM | 100 | — | 80 | 20 |
| | | | ODA | | | | | |
| Example 10 | BPADA | PMDA | 4,4′- | — | 90 | 10 | 100 | — |
| | | | ODA | | | | | |
| Example 11 | BPADA | BPDA | 4,4′- | — | 85 | 15 | 100 | — |
| | | | ODA | | | | | |
| Example 12 | BPADA | ODPA | 4,4′- | — | 75 | 25 | 100 | — |
| | | | ODA | | | | | |
| Example 13 | BPADA | BTDA | 4,4′- | — | 75 | 25 | 100 | — |
| | | | ODA | | | | | |
| Example 14 | BPADA | TMEG | 4,4′- | — | 80 | 20 | 100 | — |
| | | | ODA | | | | | |
| Example 15 | BPADA | ODPA | 4,4′- | BAPP | 80 | 20 | 80 | 20 |
| | | | ODA | | | | | |
| Example 16 | BPADA | BTDA | 4,4′- | APB | 70 | 30 | 70 | 30 |
| | | | ODA | | | | | |
| Comparative | BTDA | — | 4,4′- | — | 100 | — | 100 | — |
| Example 1 | | | ODA | | | | | |
| Comparative | BPADA | — | 4,4′- | — | 90 | — | 100 | — |
| Example 2 | | | ODA | | | | | |

### [Example 17]

Solution comprising 15 wt % of polyamic acid copolymer prepared by the Example 1, and 85 wt % of NMP was coated on a glass plate using a coater and left at room temperature for about 1 hour, and then maintained in an oven substituted with nitrogen at 140° C. for about 1 hour. The temperature was elevated to 200° C. at a speed of 5° C. per minute and the reactant was maintained at 200° C. for 30 minutes, the temperature was then elevated to 300° C. at a speed of 5° C. per minute and the reactant was maintained again at 300° C. for 30 minutes, and finally the reactant was slowly cooled to prepare a heat resistant adhesive comprising polyimide copolymer. Properties of the obtained heat resistant adhesive were measured by the following methods, and the results are shown in Table 2.

### [Tests]

1) Inherent viscosity: measured at a concentration of 0.5 wt % using polyamic acid copolymer before curing to polyimide copolymer, and NMP as a solvent.

2) water absorption rate: After being immersed in distilled water at room temperature for 24 hours, moisture contents were measured to obtain the water absorption rate.

3) Glass transition temperature (Tg): measured using DSC.

4) Adhesion strength: Adhesive film with a thickness of 25 μm was inserted between two electrolytic copper foils, and they were adhered in a press maintained at 280° C. with a pressure of 30 kg/cm² for 20 seconds. 180° peel strength of the obtained laminate was measured to represent adhesion strength.

### [Examples 18 to 33 and Comparative Examples 3 to 4]

The heat resistant adhesive comprising polyimide copolymers were prepared by the same method as in Example 17, except that the polyamic acid copolymer of Examples 2 to 16, and Comparative Examples 1 and 2 was used. Then, Properties of the obtained heat resistant adhesive were measured by the same method as in Example 17, and they are shown in the following Table 2.

TABLE 2

| | | water | | Adhesion |
|---|---|---|---|---|
| | viscosity | absorption | | strength |
| | (dl/g) | rate (%) | T_{g} (° C.) | (kg/cm) |
| Example 17 | 0.46 | 1.3 | 220 | 1.1 |
| Example 18 | 0.39 | 1.3 | 220 | 1.1 |
| Example 19 | 0.38 | 1.3 | 121 | 1.2 |
| Example 20 | 0.37 | 1.5 | 222 | 1.3 |
| Example 21 | 0.34 | 1.6 | 237 | 1.4 |
| Example 22 | 0.44 | 1.3 | 206 | 1.3 |
| Example 23 | 0.46 | 1.1 | 208 | 1.8 |
| Example 24 | 0.36 | 1.1 | 209 | 1.4 |
| Example 25 | 0.47 | 1.0 | 205 | 1.5 |
| Example 26 | 0.46 | 1.4 | 212 | 1.5 |
| Example 27 | 0.40 | 1.2 | 252 | 0.6 |
| Example 28 | 0.43 | 1.3 | 230 | 0.9 |
| Example 29 | 0.21 | 1.5 | 231 | 1.2 |
| Example 30 | 0.39 | 1.5 | 226 | 1.6 |
| Example 31 | 0.27 | 1.5 | 210 | 1.5 |
| Example 32 | 0.31 | 1.5 | 219 | 1.4 |
| Example 33 | 0.34 | 1.7 | 208 | 1.3 |
| Comparative | 0.38 | 2.1 | 277 | 0.1 |
| Example 3 | | | | |
| Comparative | 0.18 | 2.0 | 220 | No film formation |
| Example 4 | | | | |

As shown in Table 2, Examples 17 to 33 of the present invention has low water absorption rates and glass transition temperatures, and superior adhesion strength due to having high viscosities compared to Comparative Examples 3 and 4.

### [Examples 34 to 50 and Comparative Example 5 to 6]

Each of solution comprising 15 wt % of polyamic acid copolymer prepared by and methods as in Examples 1 to 16, and Comparative Examples 1 and 2, and 85 wt % of NMP was used, and was cured under the same conditions as in Example 18 by coating on a copper foil instead of a glass plate using a coater. The adhesive strength of adhesive comprising polyimide copolymer obtained by the above were measured and the results are shown in Table 3.

TABLE 3

| | Composition | Adhesion strength (kg/cm2) |
|---|---|---|
| Example 34 | Example 1 | 1.5 |
| Example 35 | Example 2 | 1.4 |
| Example 36 | Example 3 | 1.4 |
| Example 37 | Example 4 | 1.7 |
| Example 38 | Example 5 | 1.9 |
| Example 39 | Example 6 | 1.4 |
| Example 40 | Example 7 | 1.8 |
| Example 41 | Example 8 | 1.5 |
| Example 42 | Example 9 | 1.8 |
| Example 43 | Example 10 | 1.7 |
| Example 44 | Example 11 | 1.0 |
| Example 45 | Example 12 | 1.1 |
| Example 46 | Example 13 | 1.2 |
| Example 47 | Example 14 | 1.5 |
| Example 48 | Example 15 | 1.6 |
| Example 49 | Example 16 | 1.7 |
| Example 50 | Example 17 | 1.3 |
| Comparative | Comparative | 0.6 |
| Example 5 | Example 1 | |
| Comparative | Comparative | No film formation |
| Example 6 | Example 2 | |

As shown in Table 3, Examples 30 to 50 of the present invention had superior adhesion strength compared to Comparative Examples 5 and 6, even if a copper foil instead of a glass plate was used.

As explained, the polyamic acid copolymer used in a precursor and polyimide copolymer obtained therefrom of the present invention has superior adhesion strength and simultaneously satisfies physical properties like high heat resistance and low water absorption rate, etc. and thus it can be effectively adhered parts of semiconductor devices, etc.

What is claimed is:

1. A polyamic acid copolymer of a compound represented by the following Formula 2a, 2b, 2c, and 2d: 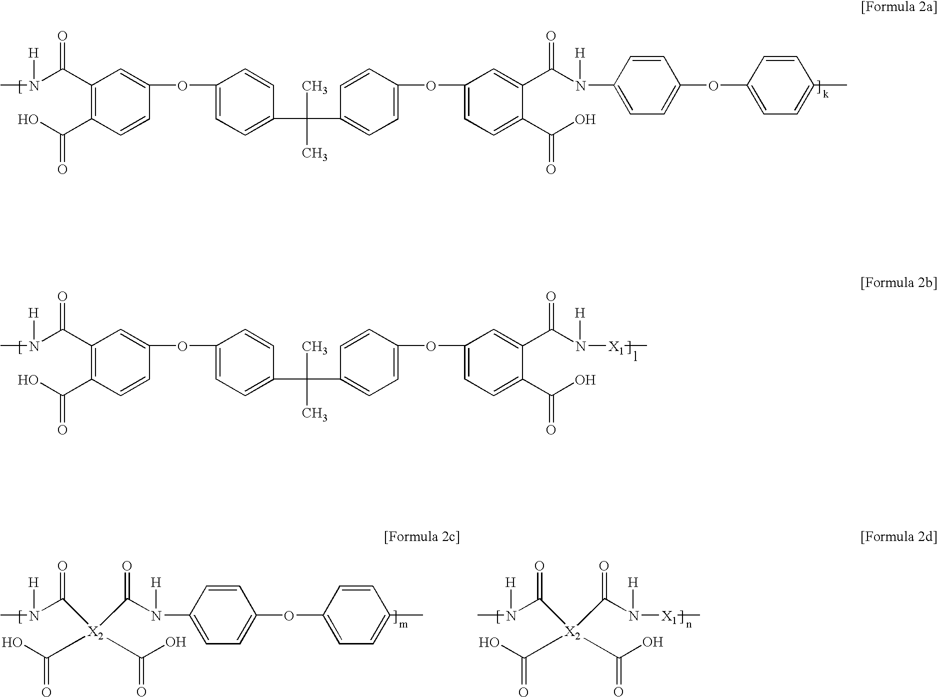
in the above Chemical Formula 2a to 2d,
X₁ is a divalent organic substance with a structure of one or more kinds selected from the group consisting of 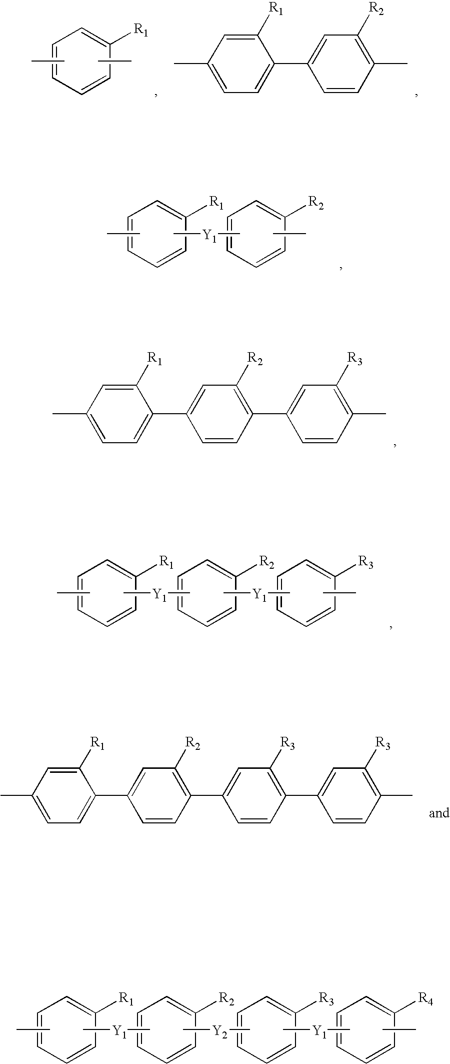
(wherein R₁, R₂, R₃, and R₄ are independently or simultaneously a hydrogen, methyl, hydroxy, or methoxy group; Y₁ and Y₂ are independently or simultaneously —O—, —CO—, —S—, —SO₂—, —C(CH₃)₂—, —CONH—, or —O(CH₂)ₙO— (wherein, n is an integer of 1 to 5.));
X₂ is a tetravalent organic substance with a structure of 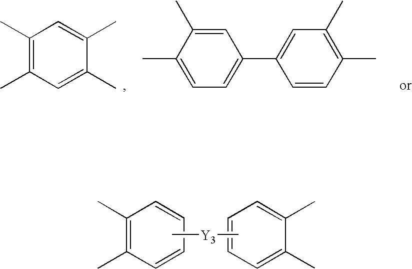
(wherein Y₃ is —O—, —CO—, or —CO₂(CH₂)ₙO₂C— (n is an integer of 1 to 5)); and
k is an integer of 1 or more; and l, m, and n are independently integers of 0 or more, but there are not 0 simultaneously, provided that k≧l, k+l>1.5(m+n), and k+m>1.5(l+n).

2. The polyamic acid copolymer according to claim 1, wherein the inherent viscosity of the polyamic acid copolymer is 0.20 to 0.5 dl/g.

3. A method for preparing the polyamic acid copolymer of a compound represented by the Formula 2a, 2b, 2c, and 2d of the claim 1, comprising the steps of:
polymerizing
a) one or more kinds of tetracarboxylic acid dianhydride; and
b) one or more kinds of aromatic diamine
by the equivalent ratio of 0.9:1˜1:0.9 under an organic solvent.

4. The method for preparing the polyamic acid copolymer according to claim 3, wherein the polymerization temperature is 0 to 60° C.

5. The method for preparing the polyamic acid copolymer according to claim 3, wherein the a) tetracarboxylic acid dianhydride is selected from the group consisting of pyromellitic acid dianhydride (PMDA), 3,3′,4,4′-biphenyl tetracarboxylic acid dianhydride (BPDA), 4,4′-oxydi(phthalic acid anhydride) (ODPA), 3,3′,4,4′-benzophenone-tetracarboxylic acid dianhydride (BTDA), trimellitic acid ethylene glycol dianhydride (TMEG), bisphenol-A-diphthalic acid dianhydride (BPADA), and a mixture thereof.

6. The method for preparing the polyamic acid copolymer according to claim 3, wherein the b) aromatic diamine is selected from the group consisting of 1,3-phenyldiamine (MPDA), 4,4′-oxydianiline (4,4′-ODA), 3,4′-oxydianiline (3,4′-ODA), 4,4′-diaminobenzanilide (DABA), 3,3′-dihydroxy-4,4′-diaminobiphenyl (HAB), 1,4-di(4-aminophenyl)butane (DAPB), 1,3-bis(3-aminophenoxy)benzene (APB), 4,4′-1,3-phenylenediisopropylidene)dianiline (PDPDA), 2,2-bis[4-(4-aminophenoxy)phenyl]propane (BAPP), bis[4-(3-aminophenoxy)phenyl]sulfone (BAPSM), and a mixture thereof.

7. The method for preparing the polyamic acid copolymer according to claim 3, wherein the organic solvent of the step a) is selected from the group consisting of N-methyl-2-pyrrolidone (NMP), N,N-dimethylacetamide (DMAc), N,N-dimethylformamide (DMA), and dimethylsulfoxide (DMSO).

8. A polyimide copolymer of a compound represented by the following Formula 1a, 1b, 1c, and 1d: 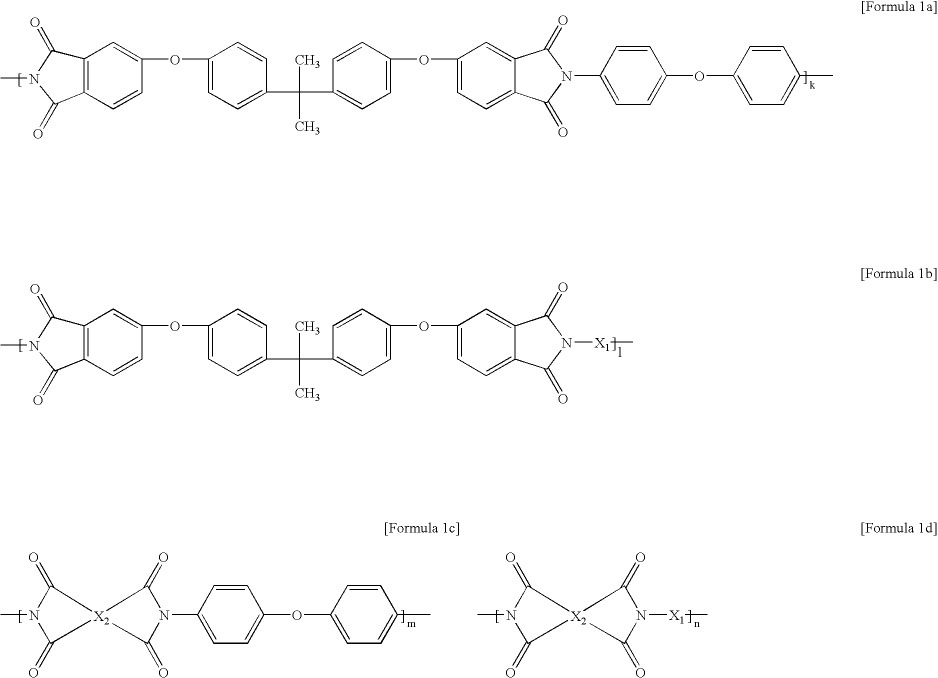
in the above Chemical Formula 1a to 1d,
X₁ is a divalent organic substance with a structure of one or more kinds selected from the group consisting of 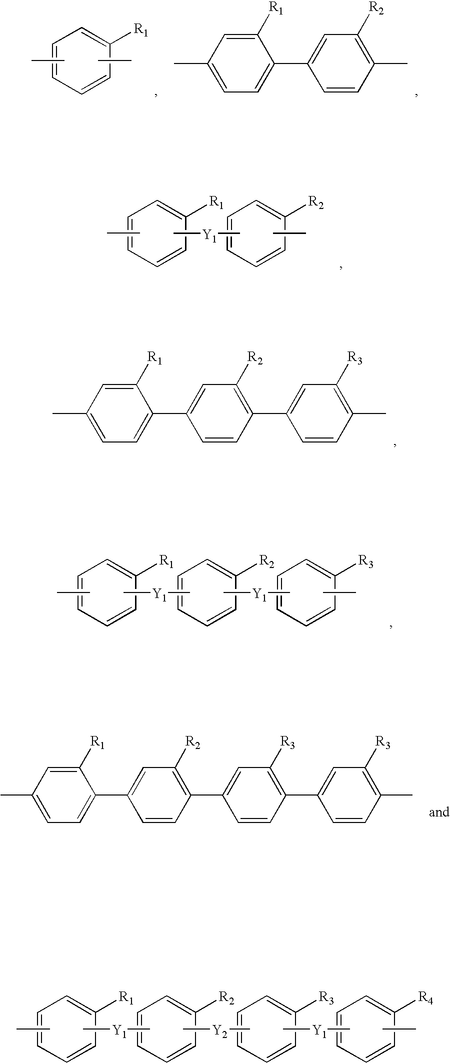
(wherein R₁, R₂, R₃, and R₄ are independently or simultaneously a hydrogen, methyl, hydroxy, or methoxy group; Y₁ and Y₂ are independently or simultaneously —O—, —CO—, —S—, —SO₂—, —C(CH₃)₂—, —CONH—, or —O(CH2)ₙO— (wherein, n is an integer of 1 to 5.));
X₂ is a tetravalent organic substance with a structure of 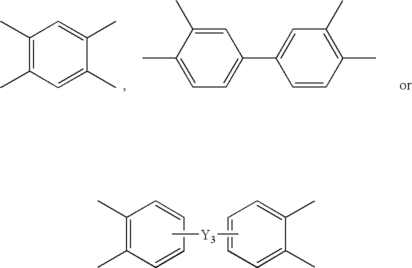
(wherein Y₃ is —O—, —CO—, or —CO₂(CH₂)ₙO₂C— (n is an integer of 1 to 5)); and
k is an integer of 1 or more; and l, m, and n are independently integers of 0 or more, but there are not 0 simultaneously, provided that k≧l, k+t>1.5(m+n), and k+m>1.5(l+n).

9. A method for preparing the polyimide copolymer of a compound represented by the Formula 1a, 1b, 1c, and 1d of the claim 8, comprising the steps of:
converting to polyimide by heating the polyamic acid copolymer of a compound represented by the following Formula 2a, 2b, 2c, and 2d: 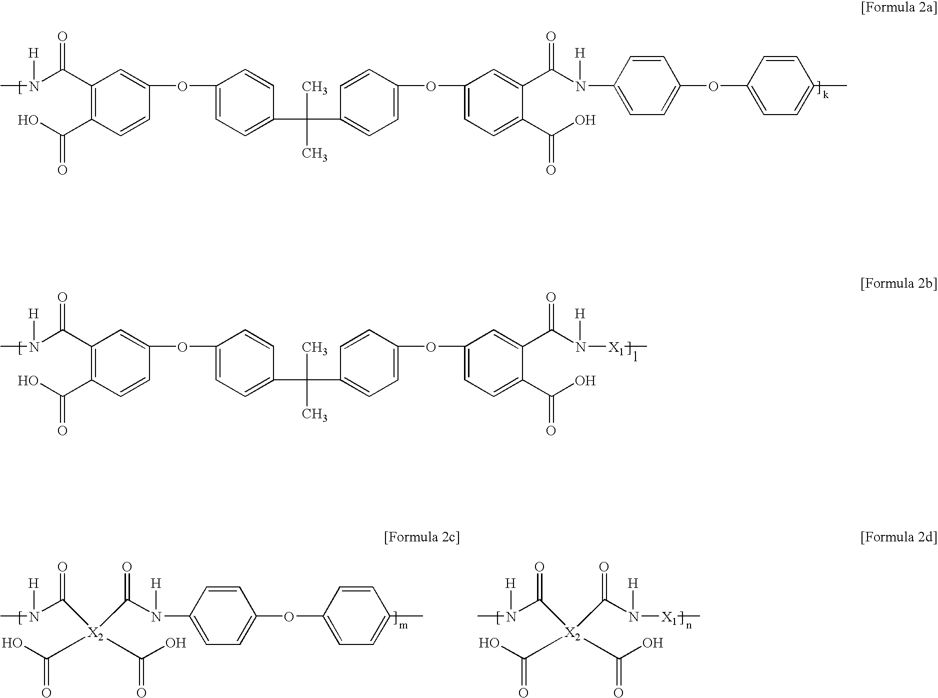
in the above Chemical Formula 2a to 2d.
X₁ is a divalent organic substance with a structure of one or more kinds selected from the group consisting of 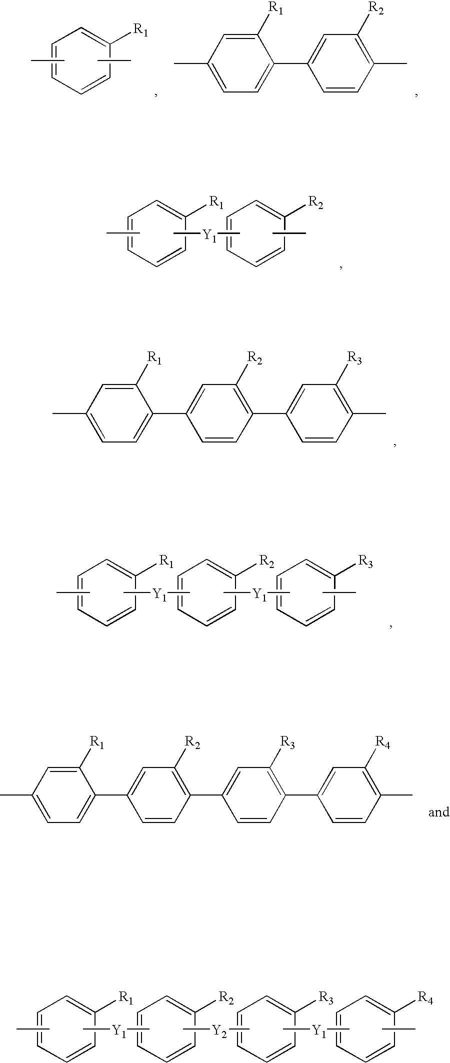
(wherein R₁, R₂, R₃, and R₄ are independently or simultaneously a hydrogen, methyl, hydroxy, or methoxy group; Y₁ and Y₂ are independently or simultaneously —O—, —CO—, —S—, —SO₂—, —C(CH₃)₂—, —CONH—, or —O(CH₂)ₙO— (wherein, n is an integer of 1 to 5.));
X₂ is a tetravalent organic substance with a structure of 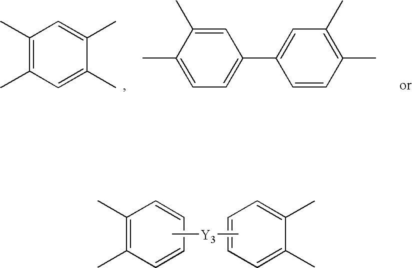
(wherein Y₃ is —O—, —CO—, or —CO₂(CH₂)ₙO₂C— (n is an integer of 1 to 5)); and
k is an integer of 1 or more; and l, m, and n are independently integers of 0 or more, but there are not 0 simultaneously, provided that k≧l, k+l>1.5(m+n), and k+m>1.5(l+n).

10. The method for preparing the polyimide copolymer according to claim 9, wherein the heating temperature is 140 to 400° C.

11. A heat resistant adhesive composition comprising:
a) the polyamic acid copolymer of a compound represented by the Formula 2a, 2b, 2c, and 2d of claim 1, or a polyimide copolymer of a compound represented by the Formula 1a, 1b, 1c, and 1d of claim 8; and b) organic solvent.

12. The heat resistant adhesive composition according to claim 11, wherein the content of the polyamic acid copolymer is 10 to 30 wt % based on total composition.

13. The heat resistant adhesive composition according to claim 11, wherein the content of the polyimide copolymer is 10 to 50 wt % based on total composition.

14. The heat resistant adhesive composition according to claim 11, wherein the organic solvent is selected from the group consisting of N-methyl-2-pyrrolidone (NMP), N,N-dimethylacetamide (DMAc), N,N-dimethylformamide (DMA), and dimethylsulfoxide (DMSO).

15. The heat resistant adhesive composition according to claim 11, wherein the composition further comprises an additive selected from the group consisting of an antifomating agent, a gel preventing agent, and a curing accelerator.

16. A semiconductor device packaged by using the heat resistant adhesive composition of claim 11.
